(19) United States
(12) Patent Application Publication
(10) Pub. No.: US 2002/0019837 A1
(43) Pub. Date: Feb. 14, 2002

(54) Method for annotating statistics onto hypertext documents

(76) Inventor: James A. Balnaves, Melrose, MA (US)

Correspondence Address: James M. Smith, Esq., HAMILTON, BROOK, SMITH & REYNOLDS, P.C., Two Militia Drive, Lexington, MA, 02421-4799, US

(21) Appl. No.: 09/845,749

(22) Filed: May 1, 2001

Related U.S. Application Data
(60) Provisional application No. 60/224,935, filed on Aug. 11, 2000.

(51) Int. Cl. G06F 15/00

(52) U.S. Cl. 707/512; 707/501.1

(57) ABSTRACT

Reporting and accuracy issues related to link navigation statistics associated with links of a webpage are addressed. To improve the reporting, a hypertext page is displayed with present statistical information associated with a hyperlink at the hyperlink on the page. The statistical information relates to a transition from the page to a linked page. In this way, the webpage is presented in a manner with which the user is accustomed, but annotated with the statistics. This methodology simplifies reporting readability in conjunction with presenting the statistical information of the webpage in a given state at the time the statistical information accurately reflects the given state.

### RELATED APPLICATION(S)

This application claims the benefit of U.S. Provisional Application Serial No. 60/224,935 filed Aug. 11, 2000, the entire teachings of which are incorporated herein by reference.

### BACKGROUND OF THE INVENTION

In the early days of the Internet, too little information about web traffic in the form of link navigation statistics was able to be provided to website hosts and managers. Link navigation statistics provide information as to how visitors of a website are using the links provided on a webpage or series of interconnected webpages. The link navigation statistics provide metrics as to which links the visitors are “clicking.” For instance, if a visitor selects a link, a record of this selection may be stored on the web server.

FIG. 1A is an example of a computer network 100a through which a visitor may visit a website. The network 100a includes a web browser 110, such as Microsoft(® Internet Explorer® or Netscape® Navigator® connected to a wide area network, such as the Internet 120. In the Internet 120, a web server 130 supports a hypothetical website, xyz.com. Traditionally, in response to an operator's request, the web browser 110 issues a hypertext mark-up language (HTML) file request to the web server 130. The form of the HTML file request is typically http://www.xyz.com, which is referred to as a uniform resource locator (URL). In turn, the web server 130 returns an HTML document corresponding to the request to be displayed as a webpage by the web browser 110 to an operator (e.g., website visitor).

FIG. 4A is an illustration of an example webpage 400a having different types of links. The various links include first and second text links 405, 415, respectively, and graphical links 410a, 410b, and 410c.

The webpage 400a also includes a drop-down menu 420 that includes representations of the links 405, 410, 415 displayed on the webpage 400a. The representations of the links in the drop-down menu 420 are selectable in a typical graphical user interface (GUI) manner.

When displayed, the webpage retrieved in this traditional manner provides no information about “link navigation” to the operator. Link navigation, in this context, means data or statistical information about the links available for selection by visitors of the webpage and/or about other webpages from which the visitors navigated.

By knowing link navigation statistics, web designers are able to optimize the layout of the links on the webpage. Additionally, website managers are able to focus on how well visitors are using the website, and advertisers are able to determine whether they are receiving appropriate exposure on a website, since they can find out accurate reports as to how many visitors of the website are selecting their link (e.g., banner advertisements).

Today, however, too much link navigation statistics information is being provided. Further, when this information is provided, it is displayed in a report format that lists the link navigation statistics at the bottom of a webpage or in a separate report page.

### SUMMARY OF THE INVENTION

The problem with providing too much link navigation statistics information is that it makes analyzing the information, regarding effectiveness of links on a website, to be a time consuming and difficult task. The problem is amplified by presenting the link navigation statistics in the report format, since the statistics, or metrics, associated with the links are disconnected from the webpage in two ways. First, the statistics are visually disconnected from the links with which the statistics are associated. Second, since webpages are constantly changing over time, the statistics reports may not accurately represent the state of the webpage at the time the statistical information was gathered. To further complicate the matter, with the advent of secure commerce, link navigation statistics gathered from clickstream data (i.e., messages having parameters passed between a browser and network server) have become less accurate since information, such as buying information and financial information, is typically encrypted when transmitted across data networks.

In general, the principles of the present invention address both the reporting and accuracy issues related to link navigation statistics associated with links of a webpage. To improve the reporting, a hypertext page is received by a node, such as a servlet. The node displays the page to present statistical information associated with a hyperlink at the hyperlink on the page.

The statistical information relates to a transition from the page to a linked page. In this way, the node presents the webpage in a manner with which the user is accustomed, but annotated with the statistics. This methodology simplifies reporting readability in conjunction with presenting the statistical information of the webpage in a given state at the time the statistical information accurately reflects the given state.

The hypertext page may be processed to identify a hypertext link. The process retrieves the statistical information corresponding to that link and generates an annotated page with a modification of the link to include the statistical information with the link when displaying the annotated page.

The process is responsive to a user selecting the hyperlink to display the linked page with the statistical information. The statistical information may be filtered as a function of user input criteria, where the user input criteria can be provided in a separate control panel.

The process optionally presents statistical information on the page in an emphasized manner. To emphasize the statistical information, the page maybe deemphasized with respect to being displayed without the statistical information. In one embodiment, color is removed from the page while the statistical information displayed on the page is displayed in color. The color of the statistical information is optionally visually suggestive of the number of times the hyperlink has been selected by visitors of the webpage. For example, a link that has been selected a great many times is displayed in green; a link that has been selected a moderate number of times is displayed in yellow; and, a link that has been selected a few number of times is displayed in red.

The statistical information can be presented in a different manner for different forms of hyperlinks. For example, the statistical information can be superimposed on respective image hyperlinks while included (e.g., appended to) in text hyperlinks associated with the image hyperlinks.

To assist in displaying the statistical information on the webpage, the process may convert the hypertext page into a format amenable to adding the statistical information. One such format is a syntactically proper HTML code, referred to as XHTML. Because browsers are generally forgiving with respect to HTML code syntax, a hypertext page written in HTML code that is not syntactically correct may be reformatted by the process to be syntactically correct. To do so, the hypertext page, for example, may be converted from HTML to XML, in which the syntax of the code composing the hypertext page is corrected. The XML is then rewritten as XHTML. The process may add the annotations to the hypertext page in either HTML or XML code formats.

In one embodiment, the statistical information is accumulated and displayed as trend information.

In the case of multiple webpages being coupled together, vertically, horizontally, or a combination thereof, local or global metrics can be provided at respective hyperlinks on the page. The user has an option to have the statistical information presented as raw data, percentages, stars or other graphic, ratios (e.g., 3/5), and so forth. Further, to simplify the use of the present invention, the page-related statistical information may be presented in a display window of a standard web browser.

The statistical information presented is optionally drawn from scalable database subsets. The database subsets draw the statistical information from a provisioning database that draws data from plural external databases. The plural external databases include at least one of the following databases: clickstream, commerce, customer records, and financial databases. The provisioning database is general, allowing for expansion to interface with and support data from future database formats.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a block diagram of an example prior art network through which a person using a traditional web browser may visit a given webpage retrieved from a web server deployed in the Internet;

FIG. 1B is a block diagram of a computer network environment in which the web browser employs an annotation servlet to annotate the given webpage, retrieved from the web server on the Internet, with link navigation statistical information;

FIG. 2 is a block diagram in which a control panel provides an interface for the web browser of FIG. 1B;

FIG. 3 is a block diagram of a set of data sources from which the annotation servlet of FIG. 1B retrieves statistical information with which to annotate the given webpage;

FIG. 4A is a diagram of an example of the given webpage retrieved from the web server of FIG. 1B;

FIG. 4B is a diagram of the given webpage having annotations of exemplary link navigation statistical information annotated by the annotation servlet of FIG. 1B;

FIG. 5 is a flow diagram of input/output flow of annotation requests and webpages into and out of the annotation servlet of FIG. 1B;

FIG. 6 is a flow diagram of a generalized process executed by the annotation servlet of FIG. 1B;

FIG. 7A is a code listing of HTML code prior to annotation by the annotation servlet of FIG. 1B;

FIG. 7B is a code listing of the HTML code of FIG. 7B following annotation by the annotation servlet of FIG. 1B;

FIG. 8 is a flow diagram of an embodiment of a top level detailed process executed by the annotation servlet of FIG. 1B to annotate a given hypertext page;

FIG. 9 is a flow diagram of an embodiment of a process used by the process of FIG. 8 to identify hypertext links on the given hypertext page;

FIG. 10 is a flow diagram of an embodiment of a process used by the process of FIG. 9 to convert the given hypertext page into a syntactically correct hypertext page;

FIG. 11 is a flow diagram of an embodiment of a process used by the process of FIG. 9 to filter the statistical information used to annotate the given hypertext page;

FIG. 12 is a flow diagram of an embodiment of a process used by the process of FIG. 8 to add statistical information to the given hypertext page;

FIG. 13 is a flow diagram of an embodiment of a process used by the process of FIG. 12 to determine the location at respective hypertext links where the statistical information will be added; and

FIG. 14 is a block diagram of a statistical information collection system used to provide data for the data sources of FIG. 3 used by the annotation servlet.

### DETAILED DESCRIPTION OF THE INVENTION

A description of preferred embodiments of the invention follows.

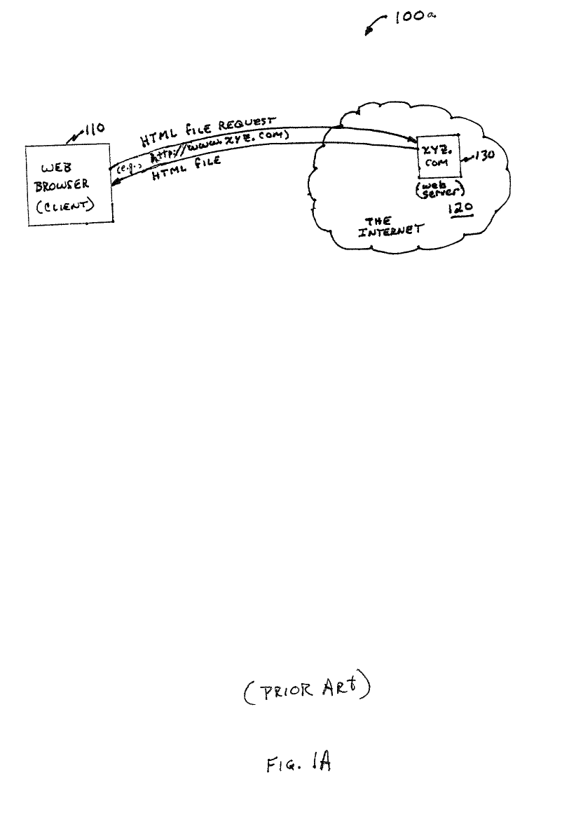

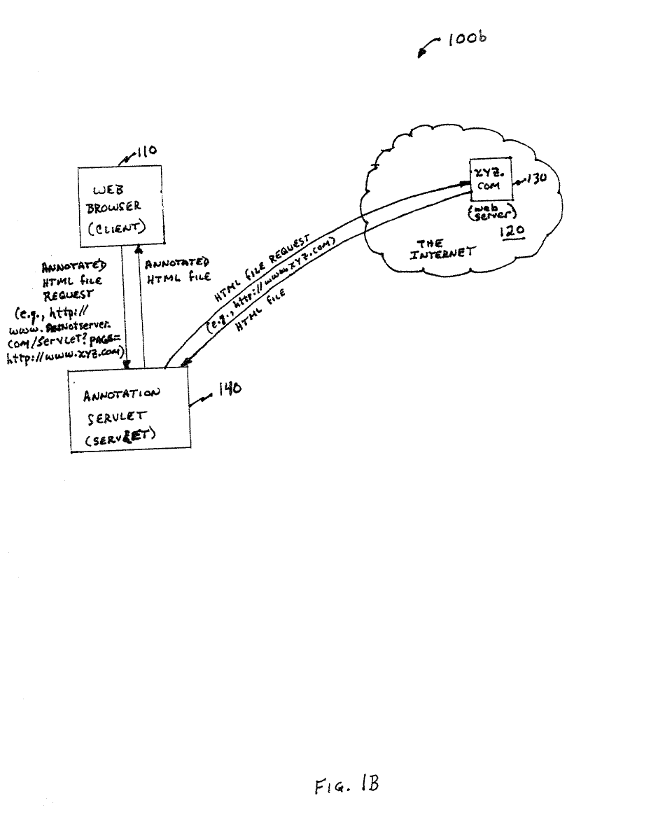

FIG. 1B is an example network 100b in which an embodiment of the present invention is deployed. In order to view statistical information related to the link navigation of the www.xyz.com webpage provided by the web server 130 on the Internet 120, the operator of the web browser 110 uses an annotation servlet 140 to provide the statistical information. The operator employs the annotation servlet 140 by adding a prefix to the URL. The prefix causes the web browser 110 to access an annotation servlet 140, while at the same time providing the annotation servlet 140 with the URL specifying the website.

The annotation servlet 140 is coupled to the Internet 120 in a manner similar to the web browser 110 and, therefore, has access to the web server 130. The annotation servlet 140 further includes processing capabilities and statistical information database access for applying the statistical information to the webpage.

In operation, the operator provides an annotated HTML file request to the web browser 110. An example of the annotated HTML file request is http://www.annotserver.com/servlet?page=http://www.xyz.com. The prefix (“http://www.annotserver.com/servlet?page=”) is basically an instruction to the web browser 110 to access the annotation servlet 140. The annotation servlet 140 parses the received request from the web browser 110. The annotation servlet 140 issues HTML file request (“http://www.xyz.com”) to the web server 130. The web server 130, in turn, sends the HTML file corresponding to the HTML file request back to the annotation servlet 140. It should be noted that the annotation servlet 140 retrieves the HTML file in the same manner as in the traditional browsing method described above.

Upon receipt of the HTML file, the annotation servlet 140 processes the HTML file. During this processing, the annotation servlet 140 applies statistical information associated with a hyperlink at the hyperlink on the page. The annotation servlet 140 forwards the annotated HTML file to the web browser 110 for display to the operator.

The webpage includes links to simplify web browsing for users. “Clickable” links provide for link navigation between webpages. Upon a user's selection of a link, a web browser receives a hypertext page composing the linked page and displays that linked page to the user. It should be understood that a clickable link can be selected in many ways, such as by computer mouse, keyboard, scanner, touch screen, voice activation, and so forth.

Since commercial webpages are typically used for revenue generating purposes, it is advantageous for website managers to understand link selection choices being made by visitors to a web page or hierarchy of webpages. By understanding hyperlink selection choices being made by the visitors, an intelligent analysis can be made regarding the webpage on many levels, such as layout, content, and visitor buying habits, optionally by the type of visitors (e.g., first time, repeat or referral visitor).

In one embodiment of the present invention, the link selection choices are represented as statistical information. Alternatively, the link selection choices may be represented as raw data. Website managers are able to improve the website to optimize revenue, for example, by having accurate and comprehensive statistical information. Further, advertisers whose advertisements are displayed on the website in the form of clickable links can be given feedback regarding the success of their advertisements.

The principles of the present invention replace and improve upon traditional list report formats by presenting the statistical information at the hyperlink on the page. In this way, the statistical information is presented with the current state of the webpage, which proves to be a more accurate and user-friendly reporting methodology than the traditional report format.

To further improve the presentation, the statistical information can be highlighted on the page. In the preferred embodiment, a server employing the principles of the present invention removes color from the webpage by converting the webpage to a grayscale equivalent and presenting the statistical information in color with a color background or other such attributes intended to highlight the statistical information.

Optionally, the color attributes are extended to provide quick-glance indications of relative or absolute measures related to the hyperlinks with which the statistical information is associated. One such color attribute system is a “stop light” color map, in which, for example, red indicates low percentage of visitor selection (e.g., less than 10%), yellow indicates higher visitor selection (e.g., 10%-25%), and green indicates highest visitor selection (e.g., greater than 25%).

The statistical information can be filtered in many ways, such as by date or visitor type. In the preferred embodiment, a control applet (i.e., small application) provides a control window with a user interface to simplify usage. The control applet provides the user-input criteria to the server, application, Java servlet, or other such processing means that annotates the webpage with the statistical information associated with the links at the links on the page.

In operation, the annotation servlet 140 receives the criteria, optionally included in the URL, from the control applet. The annotation servlet 140 retrieves a hypertext page/document from the web server 130. Since web browsers tend to be forgiving, allowing poorly written HTML to be displayed, retrieved web pages are often of improper syntax. The annotation servlet 140 processes the hypertext page to convert the HTML to a syntactically proper HTML format, known as XHTML. Syntactically proper HTML makes annotating the HTML code with the statistical information a simpler task. Therefore, since web browsers tend to be forgiving, allowing poorly written HTML to be displayed, the conversion is done to ensure good results. Thus, contrary to simple, traditional list, report formats, the annotation servlet 140 affects or adds text to the hyperlink text used by the web browser to display the hypertext page.

The statistical information that is presented on the webpage is retrieved from a data store, which is preferably a very fast database, such as an on-line analytical processor (OLAP) optimized for statistical uses in which data are stored as dimensions. It should be understood that, as in the case of visitors to a website, website managers want to view the annotated website without delay, which is why very fast databases are preferably employed.

In one embodiment, the data store gathers raw data from databases, typically relational databases or log files, that constantly monitor website traffic of visitors coming into and departing from the website. These databases may include but are not limited to clickstream, commerce, customer records, and financial databases. In this way, the data store can cross-reference the gathered raw data and can be modified to account for changes in data storage format of future relational databases.

Beyond displaying the webpage annotated with the statistical information at the hyperlinks, the servlet, employing the principles of the present invention, maintains the “look and feel” of the webpage by responding to a user selecting the hyperlink to display the linked page with statistical information. The traditional list reporting technique merely results in the linked webpage having a list of statistical information located apart from the hyperlinks with which the statistical information is associated. The present invention, in contrast to the traditional list reporting technique, results in a user-friendly, accurate, and intuitive report presenting page related statistical information to the user.

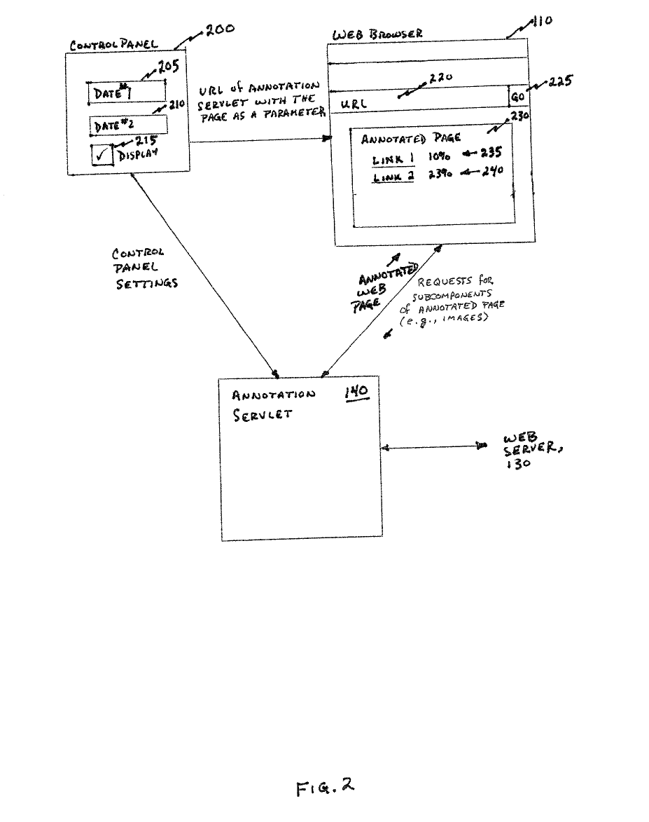

FIG. 2 is a block diagram in which the web browser 110 is again in communication with the annotation servlet 140. However, to simplify use of the annotation servlet 140 for the operator, a control panel is included in this embodiment. The control panel 200 is used by an operator investigating link navigation of a website.

The control panel 200 communicates with the web browser 110 or annotation servlet 140. The control panel 200 can be a separate application or applet from the web browser 110 or can be an extension of the web browser 110. Further, the control panel 200 is provided on or with the same display generated by the web browser 110 but is not generated by the web browser in this embodiment.

The control panel 200 includes fields 205, 210, and 215. The first field 205 and second field 210 are range dates for which the operator wishes to view the link navigation statistics of the webpage. The third field 215 is a check box selected by the operator to enable and disable display of the annotations on the webpage.

It should be understood that alternative embodiments can include as many query boxes as desired. Such query boxes can be operator-selected and/or provided to the operator by a programmer. The control panel may also include a query field into which the operator submits a URL of a webpage for annotation. Alternatively, any graphical user input (GUI) technique, rather than text entry, can be used to select webpages, date ranges, or other operator input to define the annotated webpage.

The control panel 200 collects all the information provided by the operator, as set forth in the query inputs 205, 210, 215. The inputs, sometimes referred to as criteria or constraints, are applied to a uniform resource locator (URL), where the inputs are encoded as URL parameters.

The control panel 200 provides control panel settings to the annotation servlet 140, which, of course, may include transmission of the URL across a network (not shown). The control panel also directs the web browser 110 to the URL of the annotated page.

Upon receipt of the URL, the annotation servlet 140 accesses the web server 130 to get the requested HTML file (described above in reference to FIG. 1B). The annotation servlet 140 processes the webpage once received, and provides the annotated webpage to the web browser 110.

In the display generated by the web browser 110, an address line 220 allows the operator to input the URL, optionally with the annotation servlet prefix. In a typical web browser manner, a “go” button 225, when selected by the operator, instructs the web browser 110 to send requests for subcomponents of the annotated page to the annotation servlet 140.

An example of an annotated page 230 is provided in the web browser 110. The annotated page 230 includes two links, a first link 235 and a second link 240. As shown, the annotated page 230 indicates that the first link 235 has been selected by visitors of the webpage 10% of the time. The annotated page 230 further indicates that the second link 240 has been selected by visitors of the webpage 23% of the time.

To graphically distinguish the different link selection rates by visitors, the 10% and 23% annotations may be distinguished from one another, and the rest of the contents of the annotated page 230, by having different colors, shades, text sizes, text style (e.g., bold, italic), or other means for emphasizing the selection rates to the operator. In addition, to make the annotations stand out from the rest of the contents of the page, the color may be removed from the page and replaced with gray-scale equivalents.

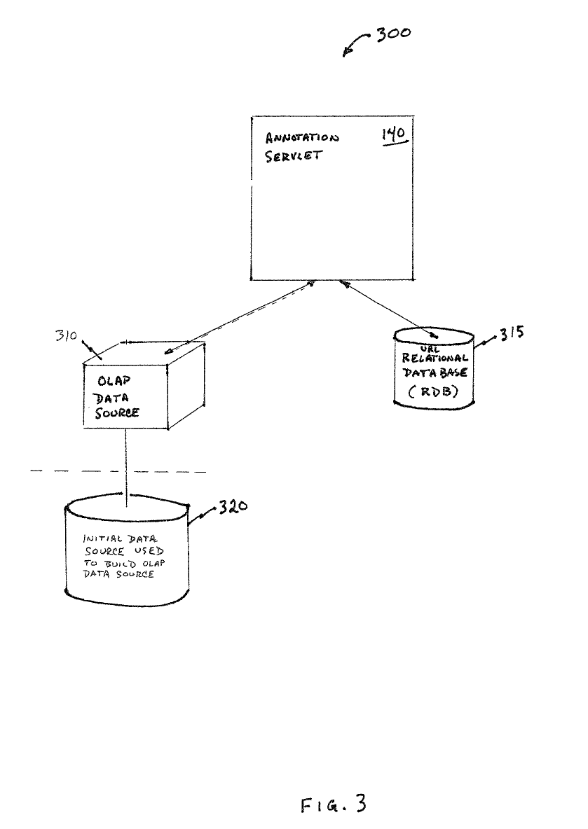

FIG. 3 is a block diagram of an embodiment of an annotation subsystem 300. The annotation subsystem 300 includes the annotation servlet 140. The annotation servlet 140 accesses various databases. In the embodiment shown, the databases include an on-line analytical processor (OLAP) data source 310 and relational database (RDB) 315.

The OLAP data source 310 stores data as dimensions, making retrieval of data an extremely fast process for the annotation servlet 140. The reason it is desirable for the annotation servlet 140 to have retrieval of data extremely fast is because the operator expects to see the annotated web page as fast, or nearly as fast, as the web page without annotations.

The OLAP data source 310 is initialized by an initial data source 320, which comprises at least one of the following sources: log file, relational database, XML file, or other such data source. The initial data source 320 stores data that answers the question “who has clicked on these links” for the web page being processed by the annotation servlet 140. In other words, the initial data source 320 includes data of history with regard to the webpage. History can be learned or retrieved, as discussed immediately below.

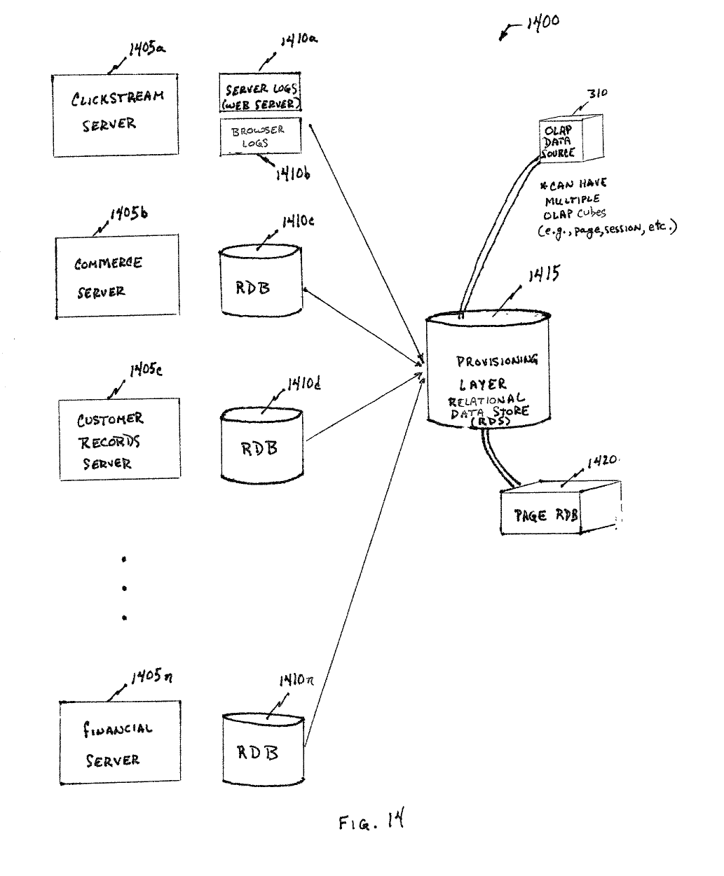

Databases from which link navigation statistical information is retrieved include clickstream, commerce, customer records, and financial databases (discussed later in reference to FIG. 14). The OLAP data source 310 is incrementally updated by a separate system (also discussed later in reference to FIG. 14) that has access to these databases. Once being updated by this separate system, the initial data source 320 is no longer used by the OLAP data source 310.

The URL relational database (RDB) 315 is optionally used to map long URLs to identifiers (IDs). An ID is an identifier for a page, such as an index value. By mapping long URLs to IDs, the annotation subsystem 300 is able to minimize usage of storage memory and operational memory.

It should be understood that, although specific database types have been described, any database type may be used, depending upon the speed at which the annotation servlet 140 is required to provide annotated webpages to the operator. In addition, various types of interfaces maybe employed between the annotation servlet 140 and the databases. For example, a JAVA database connection (JDBC) may be employed to allow the annotation servlet 140 to communicate with the URL relational database 315 or OLAP source 310. Customized or commercial interfaces and/or databases may be used to implement the annotation subsystem 300.

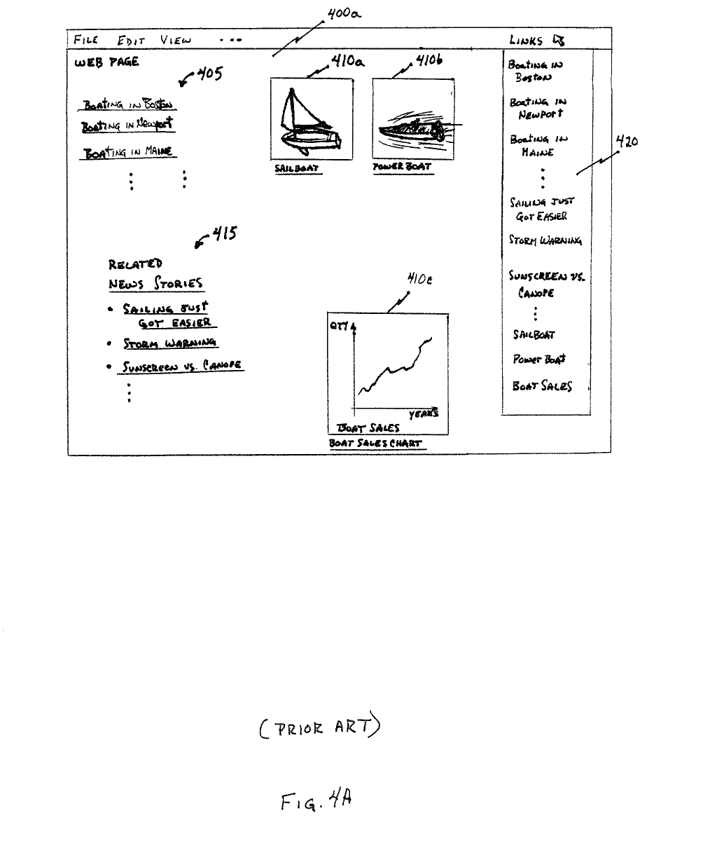

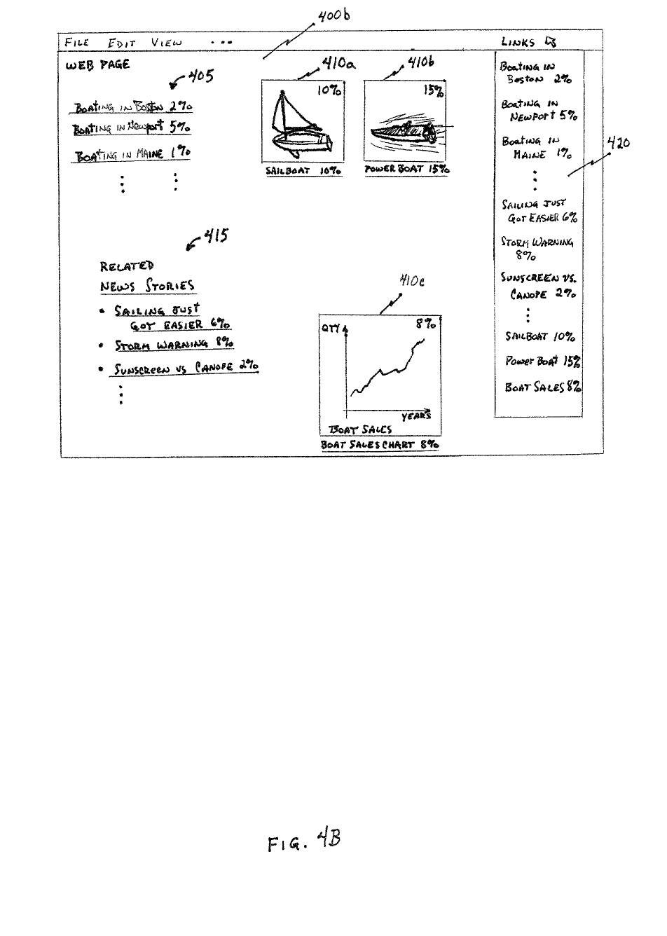

FIG. 4B is an illustration of a webpage 400b having different types of links capable of being annotated by the annotation servlet 140. The various links include first and second text links 405, 415, respectively, and graphical links 410a, 410b, and 410c.

The annotation servlet 140 annotates the links with link navigation statistical information in a manner appropriate for the given link. For example, the first and second text links 405, 415 are annotated with statistical information at the links by having the statistical information appended to the text of the links. As shown, the first text links 405 have the statistical information (i.e., 2%, 5%, and 1%) appended to the end of the text composing the links. Similarly, the second text links 415 have respective statistical information (i.e., 6%, 8%, 2%) appended to the end of the text composing the links.

In the case of the graphical links 410a, 410b, and 410c, the statistical information (i.e., 10%, 15%, 8%, respectively) is superimposed on the respective graphics. Though the statistical information is superimposed at the upper-right of the graphic, alternative placements of the statistical information can be used. Further, the graphical links 410a, 410b, and 410c include respective text links found beneath the graphics. These text links also have the statistical information (i.e., 10%, 15%, 8%) appended to the end of the text.

The webpage 400b also includes a drop-down menu 420 that includes representations of the links 405, 410, 415 displayed on the webpage 400b. The representations of the links in the drop-down menu 420 are selectable in a typical graphical user interface (GUI) manner. The statistical information corresponding to the links is also listed with the representations of the links in the drop-down menu 420. It should be understood that the drop-down menu 420 is a specific embodiment of a general class known as “form elements.” The annotation servlet 140 is capable of annotating other types of form elements (e.g., push buttons) in a similar or suitable manner.

To emphasize this statistical information and/or to allow the operator to more clearly distinguish the statistical information from the rest of the web page, the annotation servlet 140 (FIG. 3) may include processing to make this statistical information highly discernable. For example, the color can be removed from the page, and the statistical information can be provided in color.

The color associated with the statistical information may be visually suggestive of the number of times the hyperlink has been selected by visitors of the webpage. For example, the more times the link has been chosen, the brighter the color of the statistical information may be. In one embodiment, the statistical information conforms to a stoplight code, where links that have been selected infrequently have the statistical data at the link presented in red; the links that have been selected at moderate frequencies are displayed at the respective links in yellow or orange; and, the links that are selected at high frequencies are presented at the respective links in green.

In one embodiment, the color coding, placement of statistical information, and other aspects related to the presenting of the statistical data can be customized by the operator.

Because operators are familiar with a webpage having a particular layout, format, and feel, the annotation servlet 140 attempts to keep all those properties in tact, so as to keep the same look and feel for operators when analyzing the statistical information related to link navigation. For example, although color may be removed from the webpage text, the size and style attributes are attempted to be retained wherever possible, again, to retain the same look and feel for the operator.

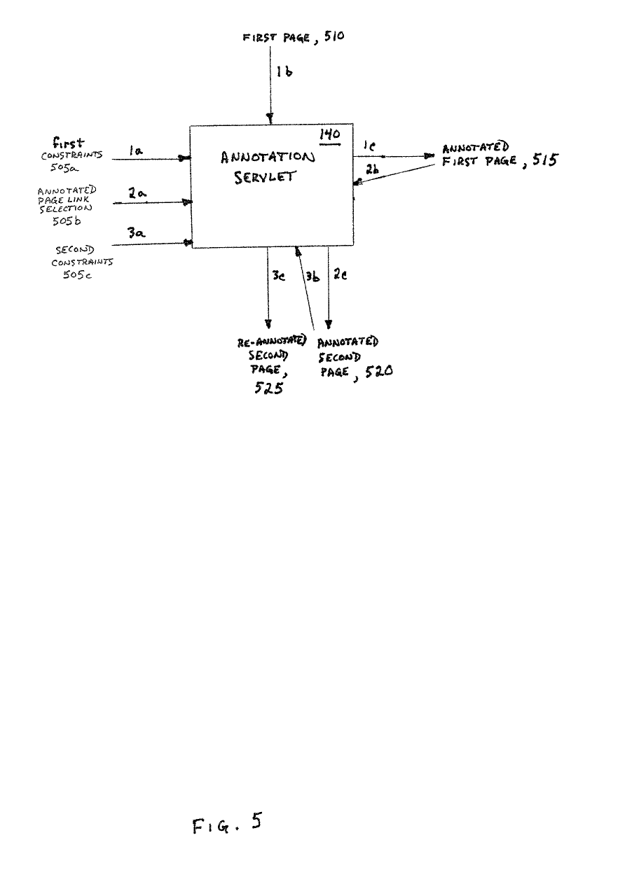

FIG. 5 is a block diagram indicating process steps for applying annotations of link navigation to webpages (e.g., webpage 400b) by the annotation servlet 140. In a first constraint change, the annotation servlet 140 receives a first set of constraints 505a for annotating a first page 510. The annotation servlet 140 processes the first page 510, producing an annotated first page 515.

Next, an annotated page link selection 505b is received by the annotation servlet 140. In this case, the operator selected a link on the annotated first page 515, and a second page is produced in response to the selection of that link. The page associated with the selected link is provided as an annotated second page 520. Thus, the annotation servlet 140 can be used to generate an annotated page in an automated manner in response to a link selection at the first annotated page 515.

A second constraint change presents the annotation servlet 140 with a second set of constraints 505c. The second set of constraints 505c includes a revised first set of constraints for displaying the statistical information associated with the annotated second page 520. The control panel 200 (FIG. 2) may have been used to apply the second set of constraints 505c. For example, different date ranges may have been entered into the control panel 200, which then issues the entered data ranges to the annotation servlet 140, as described above in reference to FIG. 2.

Continuing to refer to FIG. 5, in response to the second constraint change, the annotation servlet 140 applies the second set of constraints 505c to the annotated second page 520, thereby generating a twice-annotated second page 525. The annotation process can continue any number of times to refine the statistical information displayed at the links on the annotated second page 520. Of course, a new page can be requested for annotation at any time. The latest set of constraints are stored by the annotation servlet 140 and applied each time a new page is requested. It should be understood that the statistical information applied by the annotation servlet 140 during these processes is accessed from the databases 310, 315, 320 (FIG. 3) in a manner described above.

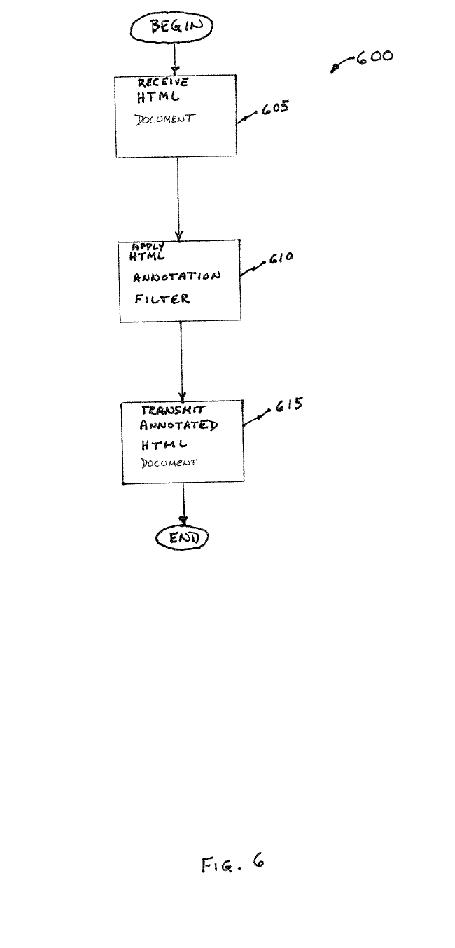

FIG. 6 is a generalized process 600 applied during the annotation process. An HTML document is received in Step 605. In Step 610, the process 600 applies an HTML annotation filter. This HTML annotation filter includes the operations applied by the annotation server 140. In Step 615, the HTML annotation filter transmits an annotated HTML document to, for example, the web browser 110 (FIG. 1B).

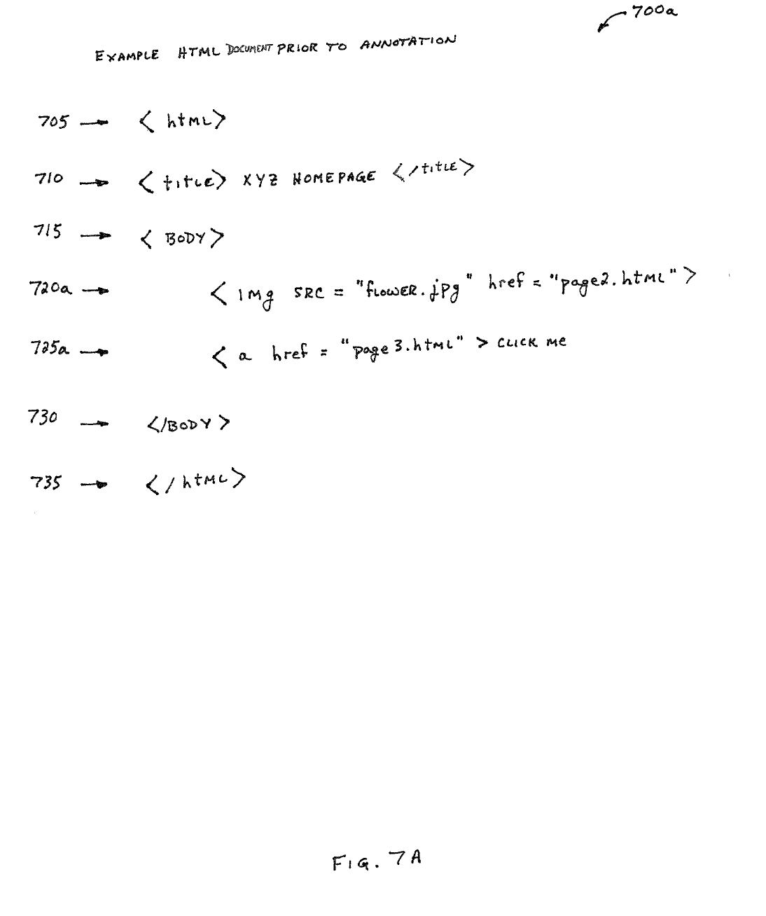

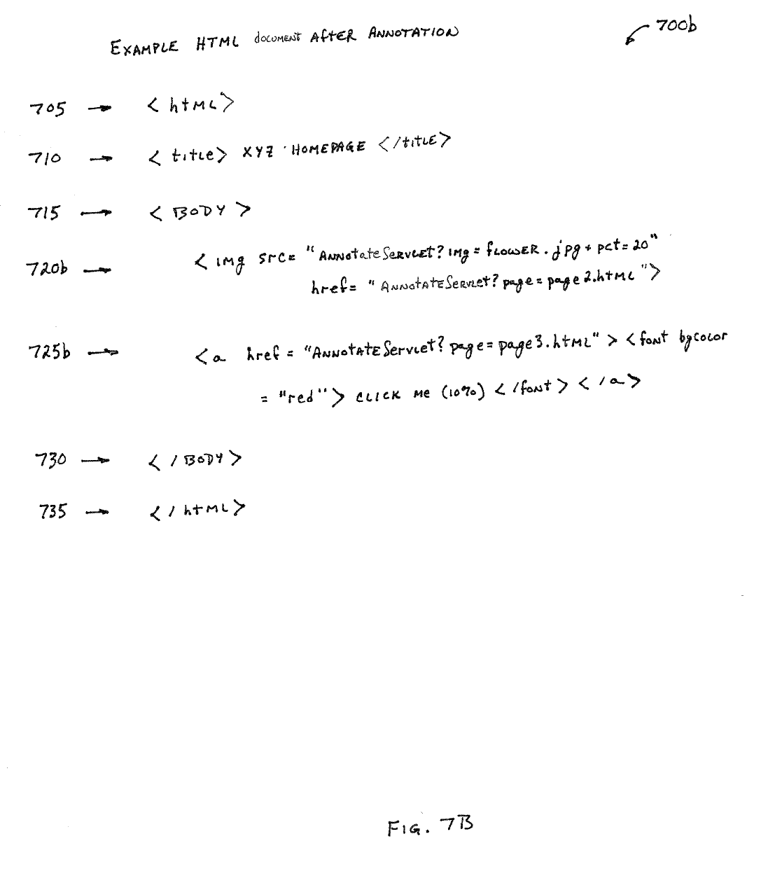

To illustrate the filtering applied to the HTML document, FIGS. 7A and 7B provide an example of an HTML document prior to annotation and after annotation, respectively.

Referring first to FIG. 7A, an example HTML document 700a lists HTML code prior to being annotated by the HTML annotation filter in Step 610 (FIG. 6). Line 705 indicates the start of the HTML document 700a. Lines 715 and 730 define the lines between which the body of the HTML code is found. Line 735 defines the end of the HTML file 700a.

Lines 720a and 725a include HTML code to have the web browser 110 display the information contained therein. For example, in line 720a, the web browser 110 is told to display an image described in “flower.jpg”. If the image link, using the image defined in “flower.jpg” as an icon, is selected by a visitor to the page, then a reference “page 2.html” is to be retrieved and presented on the web browser 110. The visitor selects the icon by any type of supported human-to-machine interface, including computer mouse, keyboard, voice interface, and so on.

In line 725a, an anchor and end anchor instruction surrounds respective HTML code. The HTML code in line 725a instructs the web browser 110 to retrieve and display “page 3.html” in response to the visitor selecting an associated text link, “click me”.

Before annotating the HTML document 700a, the annotation servlet 140 (FIG. 3) attempts to convert the hypertext mark-up language (HTML) to a related language, such as eXtensible Mark-up Language (XML). Once in XML, which is a hierarchy of objects rather than a list as in HTML, the annotation servlet 140 is able to manipulate the lines of code. The annotation servlet 140 parses the code, then fixes the code to be well-formed HTML code, which is referred to as XHTML code.

After conversion, the annotation servlet 140 extracts link information from the well-formed HTML document to submit to the OLAP data source 310 as input. Based on the submitted input, in a typical database retrieval manner, the OLAP data source 310 retrieves respective link navigation statistical information. Finally, the annotation servlet 140 rewrites the HTML document with the statistical information.

FIG. 7B is the resulting XHTML document 700b (i.e., HTML document 700a having proper HTML syntax) with the annotations. The XHTML code 700b includes proper HTML syntax. For example, in line 725a (FIG. 7a), the </a>tag was not included; whereas, in the XHTML document 700b, line 725b includes the </a>tag, thereby providing correct syntax to properly end the line of code. By correcting the lines of code to be syntactically correct, the annotation servlet 140 is better able to annotate the HTML document. Today's browsers are able to work with HTML documents having less than perfect syntax, but, for the annotation process, the HTML document is easier to process when the HTML syntax is syntactically correct.

Examples of filtering applied by the annotation servlet 140 include adding references to the XHTML code in lines 720b and 725b. Thus, when the operator selects the flower.jpg image link, the web browser 110 calls the annotation servlet 140 with the parameters in line 720b. Further, the link navigation statistic, 20%, is included in the flower.jpg image, as discussed above. Some annotation additions include a “red” font background color applied to the “click me” text. Additionally, the link navigation statistic, 10%, has been appended to the “click.me” text, as discussed above.

Again, the statistical information included in the XHTML document 700b is retrieved by the annotation servlet 140 from a database, specifically the OLAP data source 310 (FIG. 3). If the percentage of visitors viewing the website had selected the “click me” link more than say, 25% of the time, then the background color of the font may have been annotated “green” rather than red to provide an inherently, visual, different meaning to the operator for analyzing the link navigation information.

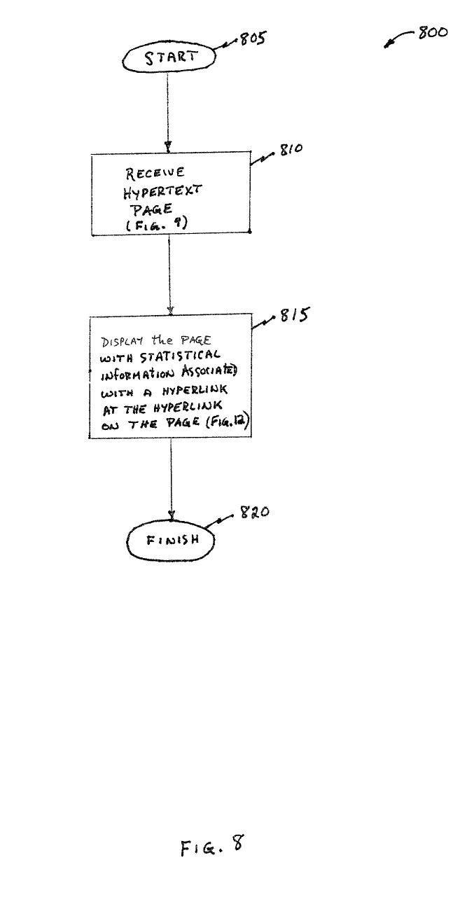

FIG. 8 is a flow diagram of a process 800 executed by a processor (not shown) supporting the annotation servlet 140 (FIG. 1B). The process 800 starts in Step 805. In Step 810, the process receives a hypertext page 700a (FIG. 7A). In Step 815, the process 800 displays the page with statistical information associated with a hyperlink at the hyperlink on the page 400b (FIG. 4B). In Step 820, the process 800 is finished.

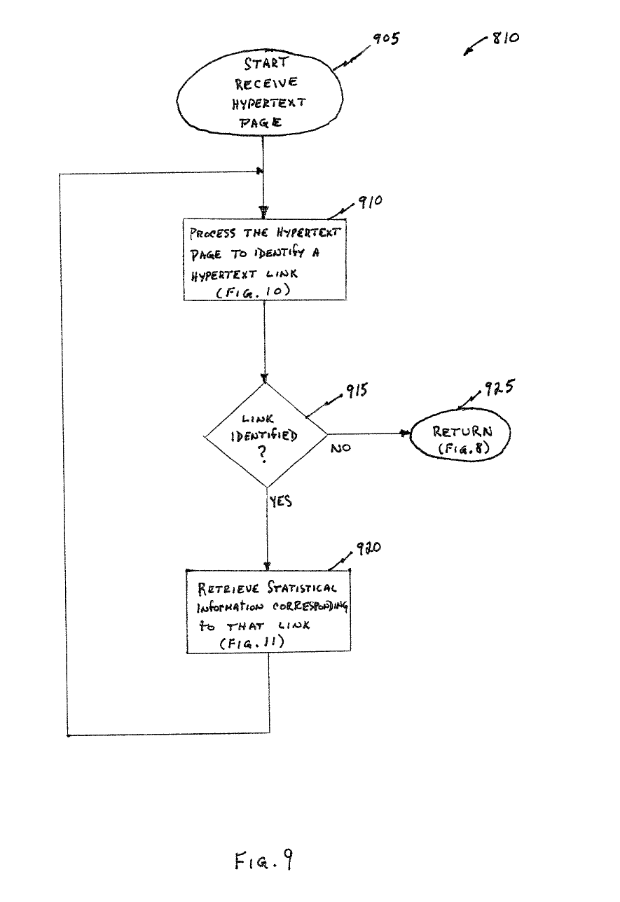

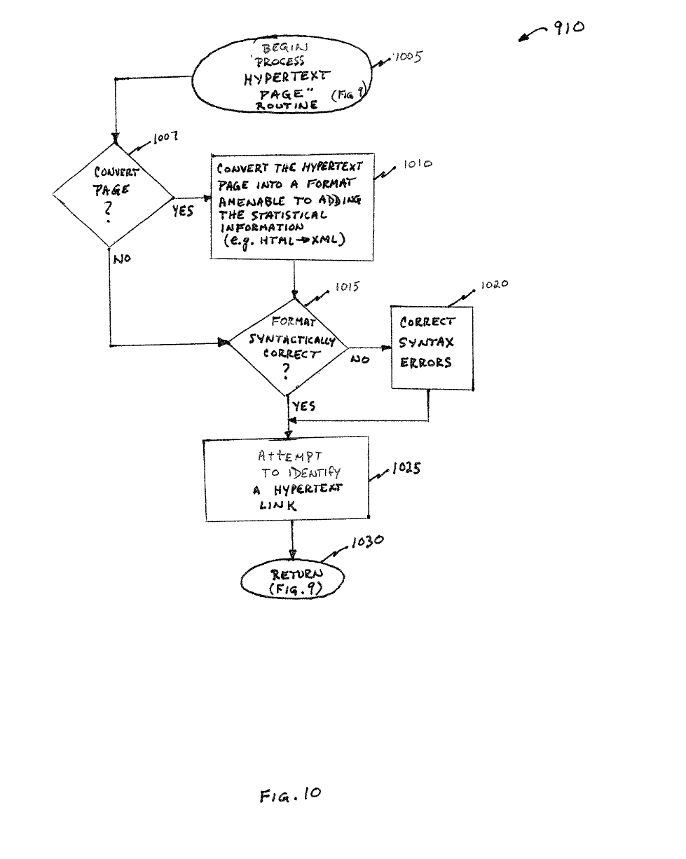

FIG. 9 is a detailed flow diagram of an embodiment of a process of Step 810. In Step 905, the process 810 begins. In Step 910, the process 810 processes the hypertext page to identify a hypertext link (e.g., links 405, FIG. 4B). The process identifying a hypertext link is shown in FIG. 10.

Referring now to FIG. 10, an embodiment of the process 910 begins in Step 1005. In Step 1007, the process 910 determines whether the page needs to be converted from a hypertext page to another format, such as XML. If the page needs to be converted, then, in Step 1010, the process 910 converts the hypertext page into a format amenable to adding the statistical information. For example, the HTML page is converted to an XML page. The underlying process of Step 1010 may be custom or commercial software. It should be understood that the processes described herein are directed to HTML and XML; however, future webpage languages are within the scope of the present invention, where the webpage language is considered a mere implementation detail.

Following Step 1007 or Step 1010, in Step 1015, the process 910 determines whether the format of the page is now syntactically correct. If the format is not syntactically correct, then, in Step 1020, the process 910 corrects the syntax errors of the page. Step 1020 may be executed by commercial software or customized software.

If the format is syntactically correct, or after the format has been corrected, the process 910 continues in Step 1025, in which the process 910 attempts to identify a hypertext link (e.g., links 405). Step 1025 may include complex processing. For example, image map hypertext links may have to be processed for determination of multiple links. Following the attempt to identify a hypertext link in Step 1030, the process 910 returns to the receive_hypertext page process 810 (FIG. 9).

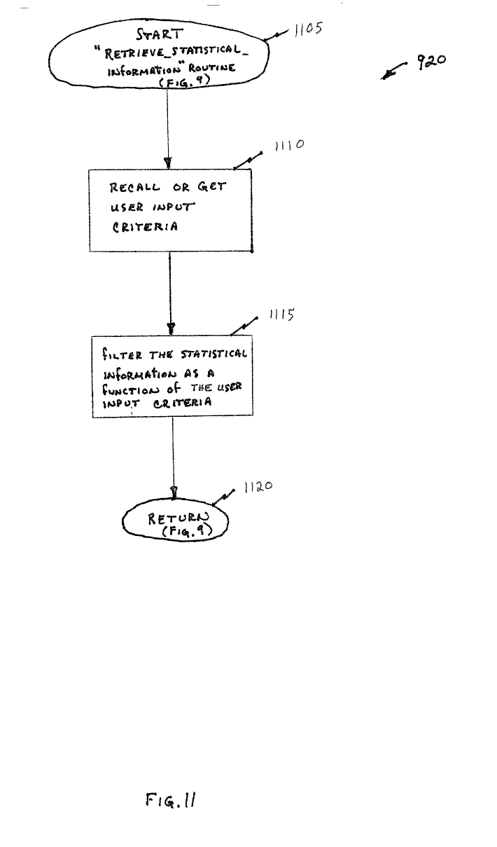

Referring again to FIG. 9, after the hypertext page 700a (FIG. 7) has been processed in Step 910 in an effort to identify a hypertext link, the process 810, in Step 915, determines whether a link has been identified. If a link has been identified, then, in Step 920, the process 810 retrieves statistical information corresponding to that link. This retrieval process is shown in FIG. 11.

Referring now to FIG. 11, the retrieval process 920 starts in Step 1105. In Step 1110, the process 920 recalls or gets the user (i.e., operator) input criteria. This criteria is the set of constraints input by the user, optionally through the use of the control panel 200 (FIG. 2).

Using the user input criteria from Step 1110, the process 920, in Step 1115, filters the statistical information as a function of the user input criteria, as described above in reference to FIG. 2. In one embodiment, the filtering is applied during the retrieval process, where the statistical information is retrieved from the OLAP data source 310 (FIG. 3) based on user input criteria. In Step 1120, the process 920 returns to the receive hypertext_page process 810 of FIG. 9.

Referring again to FIG. 9, after retrieving the statistical information corresponding to the identified link, the process 810 loops back to determine if there are other hypertext links in the page that have yet to be identified. If there are no more links on the page, as determined through the combination of Steps 910 and 915, the process 810 returns to the process of FIG. 8 in Step 925.

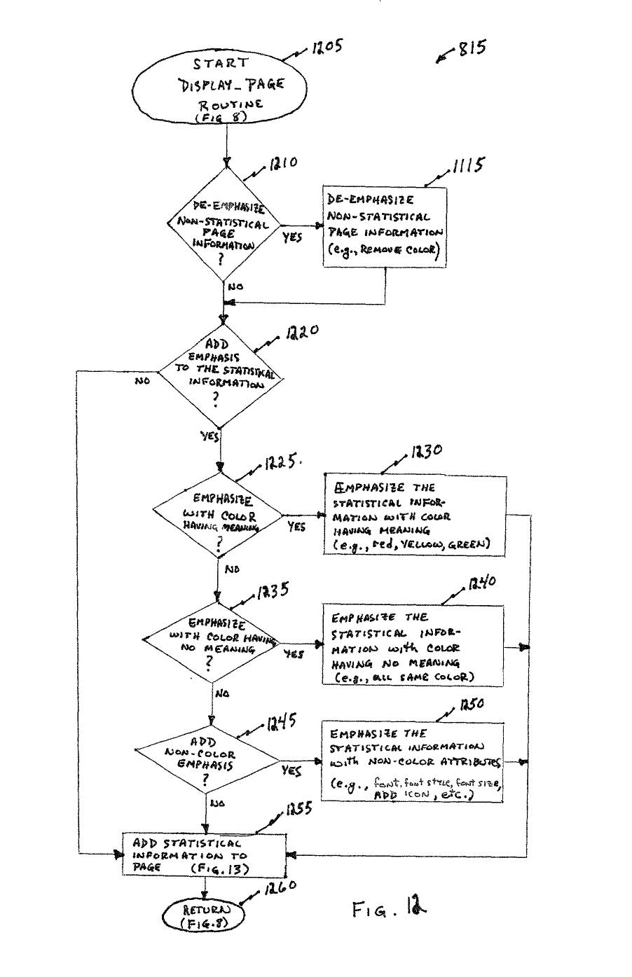

Referring again to FIG. 8, the process 800, in Step 815, after receiving the hypertext page in Step 810, displays the page with statistical information associated with a hyperlink at the hyperlink on the page. An embodiment of a process of Step 815 is provided in the form of a flow diagram in FIG. 12.

Referring now to FIG. 12, the process 815 begins in Step 1205. In Step 1210, the process 815 determines whether an optional parameter has been selected to de-emphasize non-statistical page information. If the non-statistical page information is to be de-emphasized, then, in Step 1115, the process 815 de-emphasizes the non-statistical page information. For example, de-emphasizing non-statistical page information may include removing color from the webpage.

The process 815 continues in Step 1220, where the process 815 determines whether a parameter has been selected to add emphasis to the statistical information. If no emphasis has been elected to be made to the statistical information, then the process 815 continues in 1255, where the process 815 adds the statistical information to the page, in this case, without emphasis. If, in Step 1220, the process 815 determines that emphasis is to be added to the statistical information, then the process 815 continues in Step 1225.

Steps 1225, 1235, and 1245 determine what emphasis is to be added to the statistical information to be displayed on the page. In Step 1225, the process 815 determines whether emphasis is to be added to the statistical information with color having meaning. If the answer to the query of Step 1225 is yes, then the process 815 emphasizes the statistical information with color having meaning. For example, a stoplight effect can be provided to distinguish link navigation statistics of high percentage value, to be displayed in green, from link navigation statistics of low percentage value, to be displayed in red, and link navigation statistics of medium percentage value, to be displayed in yellow. The process 815 continues in Step 1255 to add the statistical information to the page.

If Step 1225 determines that no emphasis with color having meaning is to be added to the statistical information, then, in Step 1235, the process 815 determines whether emphasis is to be added to the statistical information with color having no meaning. If yes, then, in Step 1240, the process 815 emphasizes the statistical information with color having no meaning. For example, all the link navigation statistical information may have the same color applied. The color, though meaningless, may be chosen to distinguish the statistical information from the non-statistical information on a page that has had all color removed. Following Step 1240, the process 815 continues in Step 1255 to add the statistical information to the page.

If Step 1235 determines that no color is to be added, based on a user criteria, then process 815 continues in Step 1245, where a determination is made as to whether to add non-color emphasis. If, in Step 1245, non-color emphasis is to be added, then, in Step 1250, the process 815 emphasizes the statistical information with non-color attributes. For example, various standard attributes can be applied to the statistical information to provide emphasis, such as font, font style, font size, adding an icon to the statistical information, or other standard or non-standard emphasis that can be applied to the statistical information to provide emphasis. Following Step 1250, the process 815 continues in Step 1255 to add the statistical information to the page.

It should be understood that the list of emphasis characteristics described above are a subset of possible emphasis characteristics that could be applied to the statistical information. It should be understood that alternative embodiments may combine the addition of color emphasis with the addition of non-color emphasis.

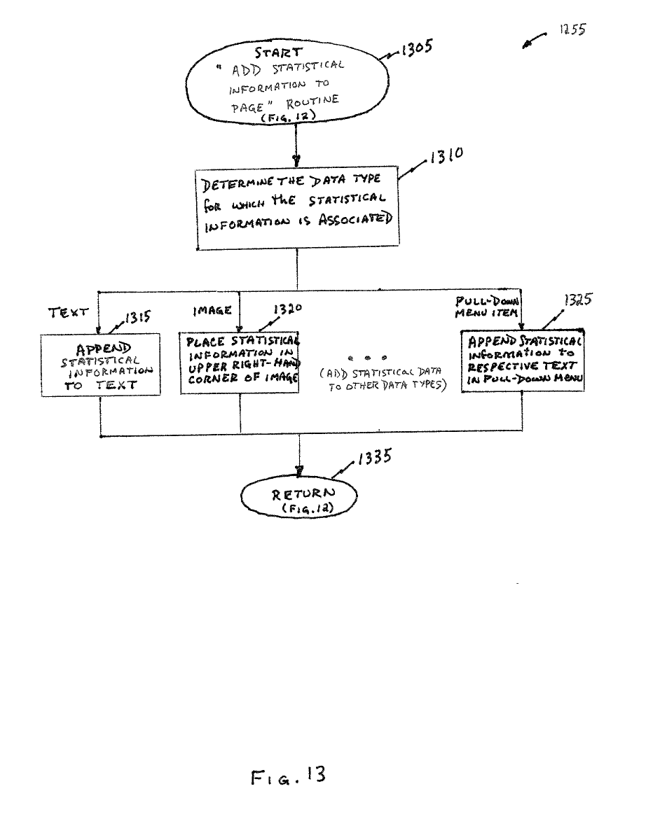

An embodiment of a process executed in Step 1255 is provided in FIG. 13. Referring to FIG. 13, the process 1255 starts in Step 1305. In Step 1310, the process 1255 determines the data type with which the statistical information is associated. Example data types include: text, image, and pull-down menu item data types.

If the data type with which the statistical information is associated is determined to be text, then, in Step 1315, the process 1255 appends statistical information to the text, in a manner described in reference to the text links 405 (FIG. 4B). If the data type is determined to be an image, then, in Step 1320, the process 1255 places the statistical information in the upper right-hand corner of the image, as described in reference to images 410a, 410b (FIG. 4B). If the data type is determined to be a pull-down menu item, then, in Step 1325, the statistical information is appended to the respective text in the pull-down menu, as understood from general graphical user interface (GUI) programming and as described above in reference to the text links 405 (FIG. 4B). It should be understood that text, image, and pull-down menu items are exemplary, and there may be other types of data that are also annotated by the annotation servlet 140.

Following the Steps of adding the statistical information to the page based on the data type for which the statistical information is associated, in Step 1335, the process 1255 returns to the process 815 of FIG. 12.

Referring again to FIG. 12, after the statistical information has been added to the page in Step 1255, the process 815, in Step 1260, returns to the process 800 of FIG. 8.

Referring again to the process 800 of FIG. 8, the process 800 is finished in Step 820.

FIG. 14 is a block diagram of a statistical information collection system 1400 used to provide data for the data sources used by the annotation servlet 140 (FIG. 3). The collection system 1400 accesses multiple servers to gather data corresponding to link navigation of website visitors. The servers include: click stream server 1405a, commerce server 1405b, customer records server 1405c, . . . , financial server 1405n.

Clickstream data include URLs and parameters appended to or contained within the URLs. The clickstream server 1405a collects clickstream data in server logs 1410a. Alternatively, the clickstream server may store information in browser logs 1410b. Typically, the logs are flat files, but may also be relational database files. The server logs 1410a are based on information generated by a web server, whereas the browser logs 1410b are based on information generated by a browser (e.g., browser 110). Either way, the logs retain information resulting from the actions (e.g., “mouse clicks”) exercised by a visitor to a webpage.

Clickstream data retained in the clickstream server 1405a may not always be accurate because encryption of URL extension information (i.e., parameters, such as credit card numbers) is used to prevent eavesdropping. Thus, if clickstream data is relied upon solely, it could cause erroneous or incomplete link navigation statistical information to be presented to an operator trying to assess the effectiveness of links on webpages in capturing the attention of visitors.

The commerce server 1405b tends to be an accurate data storage device. A commerce server 1405b is typically used to compare people who have purchased items from a given website to people who have not purchased items from the given website. For example, the commerce server 1405b may store information about visitors who have repeatedly bought items from the website over the last twelve months. A relational database (RDB) 1410c is used by the commerce server 1405b to store the commerce information.

Another server that is optionally accessed by the statistical data collection system 1400 is the customer records server 1405c. The customer records server 1405c records and retains information regarding customers, such as customers who are in a loyalty program. These customers need not necessarily be visitors to a website; the customers may be participants in, for example, a frequent flyer program. The customer records server 1405c employs a relational database 1410d to store the customer information.

There may be several other servers that are included in the data collection system 1400. One such server includes a financial server 1405n, which uses a relational database 1410n to store financial data information about customers. The financial server 1405n includes very accurate information due to the nature of financial records.

Typically, the commerce server 1405b, customer record server 1405c, and financial server 1405n are servers held very secure by companies managing the data contained within the respective databases. Some of the information may be trade secret information, while other information includes data for which the companies owe the customers a duty of care. Therefore, in order for these companies to ascertain link navigation statistics based on the information held within the respective databases of the servers, these companies must provide access to the data collection system 1400 in order to have the link navigation statistics accessible to the annotation servlet 140 (FIG. 1B) when annotating the webpages.

A vehicle used to collect the data from the logs 1410a, 1410b, and the relational databases 1410c, 1410d . . . 1410n is referred to as a provisioning layer relational data store (RDS) 1415. The data store 1415 provides a front-end to interface with the logs and databases. The data store 1415 stores its data in a generic, standard data format, which provides a common, stable, data storage facility for access by the databases, such as the OLAP data source 310 (FIG. 3), which store the statistical information used by the annotation servlet 140 (FIG. 3).

Through the use of the relational data store 1415, the present invention is not tied into any particular relational database or storage format. The front-end relational data store 1415 can be modified as new techniques for data storage come along and as new servers for gathering the data are made available. In this way, only minor modifications need to be made to the front-end of the data store 1415, and the minor modifications will not affect other processing by the data store 1415.

The data in the provisioning layer relational data store 1415 is read by the page relational database 1420. The page relational database 1420 includes information regarding a particular webpage. The page relational database 1420 is smaller than the relational data store 1415 for portability and reduced memory needs. The data in the provisioning layer data store 1415 is also accessed by the OLAP data source 310, and the retrieved data is used by the annotation servlet 140, as discussed above.

It should be understood that any of the links between data storage facilities (e.g., RDB 1410c and RDS 1415) shown in FIG. 14 may be physically separated from one another, where the data transmitted across the links are sent via networks (not shown) composing the links. The data transmitted across the links can be encrypted to maintain security where needed. Further, software used to operate any of the databases should be understood not to restrict the functions of the databases and data stores. Additionally, it should be understood that the data store 1415, page relational database 1420, OLAP data source 310, and other data stores discussed hereinabove can be (i) supported on various types of computing systems and networks and (ii) implemented with commercial and/or custom database software packages in any applicable software language.

For example, the data store 1415 and database 1420 may be maintained on a desktop computer, web server, network server, or other networked computing device. Further, various network structures, software, and hardware interfaces capable of supporting data transmission and data storage can be used to implement the various components of the statistical data collection system 1400.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of presenting page related statistical information, comprising:
receiving a hypertext page; and
displaying the page to present statistical information associated with a hyperlink at the hyperlink on the page.

2. The method as claimed in claim 1, wherein in the statistical information relates to a transition from the page to the linked page.

3. The method as claimed in claim 1, further responding to a user selecting the hyperlink to display the linked page with statistical information.

4. The method as claimed in claim 1, further including:
processing the hypertext page to identify a hypertext link;
retrieving statistical information corresponding to that link; and
generating an annotated page with a modification of the link to include the information with the link in a display of the annotated page.

5. The method as claimed in claim 1, further including filtering the statistical information as a function of user input criteria.

6. The method as claimed in claim 1, wherein the statistical information is presented on the page in an emphasized manner.

7. The method as claimed in claim 1, wherein the page is de-emphasized with respect to being displayed without the statistical information.

8. The method as claimed in claim 1, further including:
removing color from the page; and
presenting the statistical information in color.

9. The method as claimed in claim 8, wherein the color associated with the statistical information is visually suggestive of the related statistic.

10. The method as claimed in claim 1, wherein the statistical information is presented in a different manner for different forms of hyperlinks.

11. The method as claimed in claim 10, wherein the statistical information is super-imposed on respective image hyperlinks.

12. The method as claimed in claim 10, wherein the statistical information is included in respective text hyperlinks.

13. The method as claimed in claim 10, wherein the statistical information is included in a form element link.

14. The method as claimed in claim 13, wherein the form element link is a drop-down menu link.

15. The method as claimed in claim 1, further including converting the hypertext page into a format amenable to adding the statistical information.

16. The method as claimed in claim 13, wherein the format is syntactically correct.

17. The method as claimed in claim 1, wherein the statistical information includes trend information.

18. The method according to claim 1, wherein the statistical information is selectably presented as raw data, percentages, ratio, graphical indicator, or combination thereof.

19. The method as claimed in claim 1, wherein displaying the page is performed in conjunction with a standard web browser.

20. The method as claimed in claim 1, wherein the statistical information is drawn from scalable database subsets.

21. The method as claimed in claim 22, wherein the database subsets draw statistical information from a provision database that draws data from plural external databases.

22. The method as claimed in claim 23, wherein the plural external databases include at least one of the following databases: clickstream, commerce, customer records, or financial.

23. A system for presenting page related statistical information, comprising:
a digital interface to receive a hypertext page;
a database to collect statistical information related to a hyperlink on the page; and
a processor coupled to a human interface to display the page to present the statistical information associated with the hyperlink at the hyperlink on the page.

24. The system as claimed in claim 23, wherein the statistical information relates to a transition from the page to the linked page.

25. The system as claimed in claim 23, wherein the processor responds to a user selecting the hyperlink via the human interface to display the linked page with statistical information.

26. The system according to claim 23, wherein the processor:
processes the hypertext page to identify a hypertext link;
retrieves statistical information corresponding to that link; and
generates an annotated page with a modification of the link to include the information with the link in a display of the annotated page.

27. The system according to claim 23, wherein the processor filters the statistical information as a function of user input criteria.

28. The system according to claim 23, wherein the statistical information is presented on the page in an emphasized manner via the human interface.

29. The system according to claim 23, wherein the processor de-emphasizes the page with respect to being displayed without the statistical information.

30. The system according to claim 23, wherein the processor:
removes color from the page; and
presents the statistical information in color.

31. The system according to claim 30, wherein the color associated with the statistical information is visually suggestive of the related statistic.

32. The system according to claim 23, wherein the processor presents the statistical information in a different manner for different forms of hyperlinks.

33. The system according to claim 32, wherein the processor super-imposes the statistical information on respective image hyperlinks.

34. The system according to claim 32, wherein the processor includes the statistical information in respective text hyperlinks.

35. The system as claimed in claim 32, wherein the statistical information is included in a form element link.

36. The system as claimed in claim 35, wherein the form element link is a drop-down menu.

37. The system according to claim 23, wherein the processor converts the hypertext page into a format amenable to adding the statistical information.

38. The system according to claim 37, wherein the format is syntactically correct.

39. The system according to claim 23, wherein the statistical information includes trend information.

40. The system as claimed in claim 23, wherein the processor selectably presents the statistical information as raw data, percentages, ratio, graphical indicator, or combination thereof.

41. The system according to claim 23, wherein the human interface includes a standard web browser.

42. The system as claimed in claim 23, wherein the database is composed of scalable database subsets having the statistical information.

43. The system as claimed in claim 42, wherein the database subsets draw statistical information from a provisioning database that draws data from plural external databases.

44. The system as claimed in claim 43, wherein the plural external databases include at least one of the following databases: clickstream, commerce, customer records, or financial.

45. An apparatus for presenting page related statistical information comprising:
means for receiving a hypertext page; and
means for displaying the page to present statistical information associated with a hyperlink at the hyperlink on the page.

46. A computer-readable medium having stored thereon sequences of instructions, the sequences of instructions including instructions, when executed by a processor, causes the processor to perform:
receiving a hypertext page; and
displaying the page to present statistical information associated with a hyperlink at the hyperlink on the page.

47. A method of annotating a page with page related statistical information, comprising:
processing a hypertext page to identify a hypertext link;
retrieving statistical information corresponding to that link; and
generating an annotated page with a modification of the link to include the information with the link in a display of the annotated page.

48. The method as claimed in claim 47, wherein the statistical information relates to a transition from the page to the linked page.

49. The method as claimed in claim 47, further including responding to a user selecting the hyperlink to display the linked page with statistical information.

50. The method according to claim 47, further including filtering the statistical information as a function of user input criteria.

51. The method according to claim 47, wherein the statistical information is annotated on the page in an emphasized manner.

52. The method according to claim 47, wherein the page is de-emphasized with respect to being displayed without statistical information.

53. The method according to claim 47, further including:
removing color from the page; and
annotating the page with statistical information in color.

54. The method according to claim 53, wherein the color associated with the statistical information is visually suggestive of the related statistic.

55. The method according to claim 47, wherein the statistical information is annotated in a different manner for different forms of hyperlinks.

56. The method according to claim 55, wherein the statistical information is super-imposed on respective image hyperlinks.

57. The method according to claim 55, wherein the statistical information is included in respective text hyperlinks.

58. The method according to claim 55, wherein the statistical information is included in a form element link.

59. The method according to claim 58, wherein the form element link is a drop-down menu.

60. The method according to claim 47, further including converting the hypertext page into a format amenable to adding the statistical information.

61. The method according to claim 60, wherein the format is syntactically correct.

62. The method according to claim 47, wherein the statistical information includes trend information.

63. The method according to claim 47, wherein the statistical information is selectably presented as raw data or percentages.

64. The method according to claim 47, performed in conjunction with a standard web browser.

65. The method according to claim 47, wherein the statistical information is drawn from scalable database subsets.

66. The method according to claim 65, wherein the database subsets draw statistical information from a provisioning database that draws data from plural external databases.

67. The method according to claim 66, wherein the plural external databases include at least one of the following databases: clickstream, commerce, customer records, or financial.

68. A system for annotating page related statistical information, comprising:
a digital interface to receive a hypertext page;
a database to collect statistical information related to a hyperlink on the page; and
a processor coupled to the page to annotate the page to present the statistical information associated with the hyperlink at the hyperlink on the page.

69. A system for annotating page related statistical information, comprising:
means for receiving a hypertext page; and
means for annotating the page to present statistical information associated with a hyperlink at the hyperlink on the page.

70. A computer-readable medium having stored thereon sequences of instructions, the sequences of instructions including instructions, when executed by a processor, causes the processor to perform:
receiving a hypertext page; and
annotating the page to present statistical information associated with a hyperlink at the hyperlink on the page.
